(19) United States
(12) Patent Application Publication
(10) Pub. No.: US 2006/0048778 A1
(43) Pub. Date: Mar. 9, 2006

(54) Low pressure-drop respirator filter

(75) Inventors: Russell W. Johnson, Elmhurst, IL (US); Brian C. Krafthefer, Stillwater, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/221,020

(22) Filed: Sep. 7, 2005

Related U.S. Application Data
(60) Provisional application No. 60/607,755, filed on Sep. 7, 2004.

(51) Int. Cl. A62B 7/10; A62B 23/02

(52) U.S. Cl. 128/201.25

(57) ABSTRACT

A respirator filter removes toxic chemical threats by first heating an air stream, and then contacting it with a catalyst and adsorbent at conditions conducive to toxicity elimination by reaction. The air stream may then be cooled prior to being provided to a wearer of the respirator. A pump is included in various embodiments.

### RELATED APPLICATIONS

This application claims priority to U.S. Provisional Application Ser. No. 60/607,755 (entitled LOW PRESSURE-DROP RESPIRATOR FILTER, filed Sep. 7, 2004) which is incorporated herein by reference.

### FIELD OF THE INVENTION

The present invention relates to respirator filters, and in particular to a respirator filter having a low pressure drop.

### BACKGROUND

Current filters for respirators have associated high pressure drops that stress the wearer an additional amount by requiring exacerbated breathing to overcome this pressure drop. This additional stress usually occurs during high stress periods such as battle conditions or high exertion emergency conditions. Moreover, current individual air protection systems (respirators) do not provide protection against an increasing number of toxic materials. Current systems do not protect the wearer against the current desired range of chemical and biological toxicants.

Reduction of the stress of breathing through a high pressure drop respirator can be done by either reduction of the pressure drop of the filter cartridge, or by adding a pumping/flow device to pull the air through the respirator and allow the wearer to breath at a normal rate for the exertion being experienced. The former of these methods will reduce either the efficiency of the filter cartridge or the amount of flow being pulled through the cartridge. Adding a pumping/flow device adds additional weight that the wearer has to manage.

### SUMMARY

A respirator filter removes toxic chemical threats by first heating an air stream, and then contacting it with a catalyst and adsorbent at conditions conducive to toxicity elimination by reaction. The air stream may then be cooled prior to being provided to a wearer of the respirator.

### BRIEF DESCRIPTION OF THE DRAWINGS

FIG. 1 is a block diagram of a filter cartridge for a low pressure drop respirator according to an example embodiment.

FIG. 2 is a block diagram of an array of filters with micropumps according to an example embodiment.

FIG. 3 is a block flow diagram of a respirator showing heat exchangers and a heater with a CATOX element according to an example embodiment.

### DETAILED DESCRIPTION

A respirator filter removes toxic chemical threats by first heating an air stream, and then contacting it with a catalyst and adsorbent at conditions conducive to toxicity elimination by reaction. The conditions are also sufficiently severe in one embodiment to remove viability from biological threats. In one embodiment, the filter is disposed in a cartridge in a respirator. The pressure drop across the cartridge is lower than conventional filter cartridges. In addition, a air pumping/flow device such as a micropump may be added to further assist in reducing stress of breathing. The air may also be cooled to a comfortable breathing temperature.

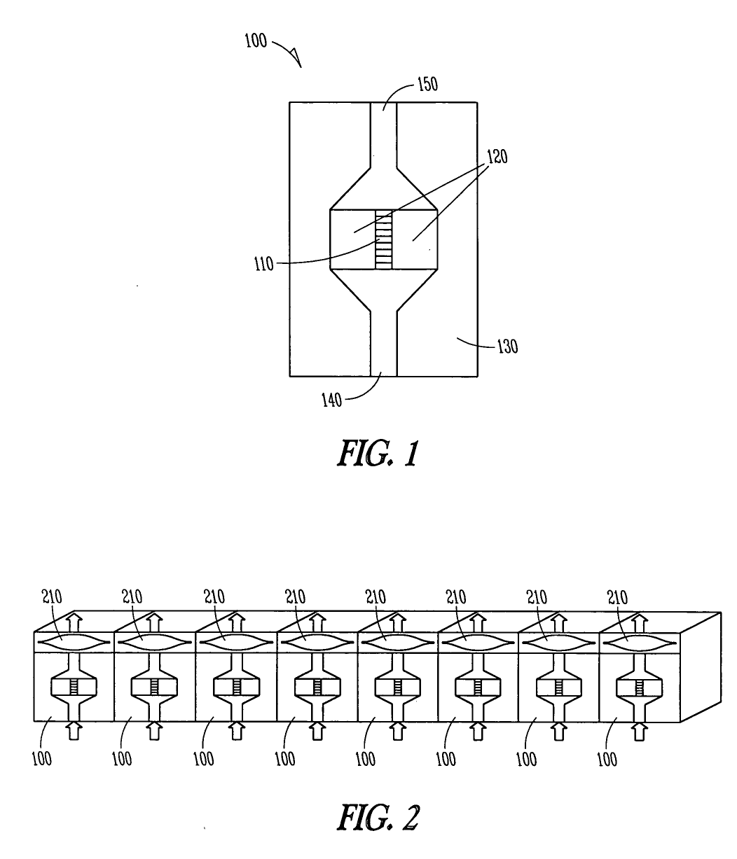

FIG. 1 illustrates a microbridge 100 that includes a heating element 110 and a CATOX element 120, a catalytic converter. The heating element 110 is placed in and surrounded by the CATOX element 120 in one embodiment. In further embodiments, the heating element may be positioned closely upstream from the CATOX element 120, or positioned proximate the CATOX element 120 to efficiently provide heated air to the CATOX element 120. If placed too far from the CATOX element 120, air may need to be heated to a higher temperature if it cools prior to passing through the CATOX element 120. In one embodiment, the heater 110 and CATOX element 120 are packaged in an insulating material 130, such as silicon. Air flow is provided by passages 140 and 150 disposed on both sides of the CATOX element 120. A catalytic operation occurs in CATOX element 120 at temperatures to reduce chemicals sufficient to eliminate toxicity of toxic chemicals in the incoming air.

A respirator is configured by placing a MEMS micro pump downstream of a microbridge configuration consisting of a heater and a catalytic converter, as illustrated in an array of such microbridges 100 in FIG. 2. Micro pumps 210 are disposed downstream from the microbridges. In one embodiment, the array may consist of multiple rows and columns of microbridges and pumps. In a further embodiment, microbridges may share one or more pumps.

In one embodiment, the catalytic converter CATOX element 120 comprises a noble metal distributed on a ceramic support. Platinum, palladium, nickel, cobalt and iron are some examples of the metal. Other transition metals, and in particular Group VIII metals may also be used. Other supports include aluminum, silver and zeolite based supports. The metal acts as an oxide element (an element that uses a catalyst to facilitate oxidation) as shown in the attached figures, much like a catalytic converter for an automobile operates. One method of making the converter comprises impregnating the ceramic support with a metal salt solution and drying it to promote calcinations. The array of such configured devices as shown in FIG. 2 may be replicated over a face area similar to an existing respirator cartridge.

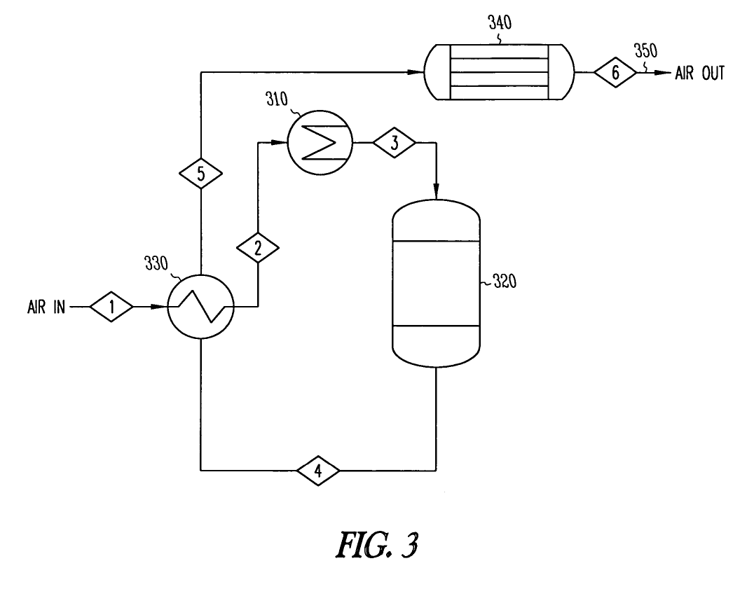

Removal of chemical and biological threats is accomplished by using the microbridge assembly to heat the incoming airstream to a temperature in the range of 100 to 450 degrees C., or from 250 to 300 in one embodiment, as illustrated in the flow diagram of FIG. 3. A heater 310 is capable of heating the airstream to temperatures in excess of 300 K. The heated airstream is contacted with an integrated catalytic material 320 for a contact time corresponding to an ambient air gas hourly space velocity (GHSV) of 1,000 to 50,000, or 10,000 to 20,000 in one embodiment. Chemical and biological threats are destroyed in one embodiment, as opposed to being stored as in typical carbon based filters. A larger number of threats, including carbon monoxide may be removed as compared to carbon based filters. The heated air is cooled by use of a recuperative heat exchanger 330 and/or dissipative heat exchanger 340 to a temperature below 45 degrees C., and in some embodiments, less than 35 degrees C. The recuperative heat exchanger 330 may be used to decrease power requirements from approximately 50 watts to approximately 20 watts. The purified and cooled breathing air is provided at 350 to an individual through a protective enclosure which may be sealed from untreated air.

In one embodiment, the pump 210 in FIG. 2 is a micro- or meso-pump. Such pumps are relatively small devices that often use an electrostatic force to move pump walls or diaphragms. The electrostatic force is often applied by applying a voltage between two paired electrodes, which are commonly attached to selected pump walls and/or diaphragms. The electrostatic force results in an attractive force between the paired electrodes, which moves the selected pump walls or diaphragms toward one another resulting in a pumping action.

The following example is an estimation of the size of the recouperator heat exchange 330, referred to as HE-1, heater 310, referred to as HE-2, and post cooler 340, referred to as HE-3. The heat exchanger efficiency for recouperation is η_{recoup}:=0, 01 . . . 1. The Heat exchanger efficiency for pos cooling is ηₚₒₛₜ:=80%. A mass flow rate calculation is first performed:

$${F}_{air} := \frac{[ 30 \cdot ( \frac{g m}{mole} ) \cdot 1 \cdot atm \cdot Flow ]}{8.314510 \cdot \frac{J}{mole \cdot K} \cdot [ [ ( {T}_{in} - 32 ) \cdot ( \frac{5}{9} ) + 273.15 ] \cdot K ]}$$

$${F}_{air} = 1.233 \frac{lb}{hr}$$

In steady state operation:

$$\begin{matrix}\begin{matrix}Δ {H}_{tot} := ( {T}_{cat} - {T}_{in} ) \cdot R \cdot Cp \cdot {F}_{air} & & Δ {H}_{tpt} = 47.423 W\end{matrix} \\ Δ {H}_{tot} = 161.813 \frac{BTU}{hr} \\ \begin{matrix}HE - 1 Duty & & Δ {H}_{HE1} ( {η}_{recoup} ) := {η}_{recoup} \cdot Δ {H}_{tot}\end{matrix} \\ \begin{matrix}HE - 2 ( Heater ) Duty & & Δ {H}_{HE2} ( {η}_{recoup} ) := ( 1 - {η}_{recoup} ) \cdot Δ {H}_{tot}\end{matrix} \\ \begin{matrix}HE - 3 ( Post Cooler ) Duty & & Δ {H}_{HE3} ( {η}_{recoup} ) := ( 1 - {η}_{recoup} ) \cdot Δ {H}_{tot}\end{matrix} \\ \begin{matrix}T1 := {T}_{in} & & & T6 := {T}_{out} & & & T3 := {T}_{cat}\end{matrix}\end{matrix}$$

Next, heat and temperature balance across HE-1 is calculated. The temperature increase of stream 1 is:
T2(η_{recoup}):=T1+η_{recoup}·(T3−T1)
T4:=T3 Assume no heat of reaction (worst case for heating)
T5(η_{recoup}):=T4−η_{recoup}·(T3−T1)

Condition Table

All Pressures assumed to be approximately 1 atm

All Temperatures are in F, % in parenthesis indicates recouperator efficiency

| | | | | | |
|---|---|---|---|---|---|
| T1 = 70 | T2(0) = 70 | T3 = 617 | T4 = 617 | T5(0) = 617 | T6 = 70 |
| | T2(50%) = 343.5 | | | T5(50%) = 343.5 | |
| | T2(75%) = 480.25 | | | T5(75%) = 206.75 | |
| | T2(80%) = 507.6 | | | T5(80%) = 179.4 | |
| | T2(90%) = 562.3 | | | T5(90%) = 124.7 | |

Heat Exchanger Duty (heat exchanged between streams)

| | | |
|---|---|---|
| ΔH_{HE1}(0) = 0 W | ΔH_{HE2}(0) = 47.423 W | ΔH_{HE3}(0) = 47.423 W |
| ΔH_{HE1}(50%) = 23.711 W | ΔH_{HE2}(50%) = 23.711 W | ΔH_{HE3}(50%) = 23.711 W |
| ΔH_{HE1}(75%) = 35.567 W | ΔH_{HE2}(75%) = 11.856 W | ΔH_{HE3}(75%) = 11.856W |
| ΔH_{HE1}(80%) = 37.938 W | ΔH_{HE2}(80%) = 9.485 W | ΔH_{HE3}(80%) = 9.485 W |
| ΔH_{HE1}(90%) = 42.68 W | ΔH_{HE2}(90%) = 4.742 W | ΔH_{HE3}(90%) = 4.72 W |

These calculations are shown as an example, and are not intended to be limiting. They may vary significantly in further embodiments without departing from the scope of the invention.

The respirator filter may be used in a single person respirator to protect at least one individual from toxic materials. It may also be used in larger respirator type devices, such as for vehicles with one or more occupants, such as automobiles, tanks, submarines, etc. In the case of vehicles, the respirator filter may utilize an air conditioning system in the vehicle to assist in pumping and cooling the air.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. A respirator comprising:
a heater;
a catalytic converter positioned proximate the heater to react with incoming air at an elevated temperature; and
a cooler coupled to the converter to cool air received from the catalytic converter.

2. The respirator of claim 1 wherein the cooler comprises a recouperator.

3. The respirator of claim 2 wherein the cooler further comprises a post cooler.

4. The respirator of claim 1 and further comprising a pump.

5. The respirator of claim 4 wherein the pump is positioned downstream of the catalytic converter.

6. The respirator of claim 1 wherein the heater provides a reaction temperature of at least approximately 100 degrees C.

7. The respirator of claim 1 wherein the heater provides a reaction temperature of at least approximately 250 degrees C.

8. The respirator of claim 1 wherein the heater provides a reaction temperature of between 100 to 450 degrees C.

9. The respirator of claim 1 wherein the heater is positioned upstream of the catalytic converter, and heats the incoming air before it reaches the catalytic converter.

10. The respirator of claim 1 wherein the heater is in thermal contact with the catalytic converter.

11. A respirator comprising:
a heater;
a reactor positioned proximate the heater to react with incoming air at an elevated temperature; and
a cooler coupled to the reactor to cool air received from the oxidizer.

12. The respirator of claim 11 wherein the reaction occurs at temperatures sufficient to eliminate toxicity of toxic chemicals in the incoming air.

13. The respirator of claim 11 wherein the reaction occurs at temperatures sufficient to remove viability from biological contaminants in the incoming air.

14. A respirator comprising:
an air intake;
a heater;
a catalytic converter coupled to receive air from the air intake and positioned proximate the heater to react with incoming air at an elevated temperature;
a pump coupled downstream from the catalytic converter to pump reacted air;
a cooler coupled to the catalytic converter to cool air received from the converter; and
an outlet to provide the air to a user of the respirator.

15. The respirator of claim 14 comprising multiple heaters, catalytic converter and pumps formed in an array.

16. The respirator of claim 15 wherein the cooler cools air to a breathable temperature.

17. The respirator of claim 14 wherein the pump comprises a micropump.

18. The respirator of claim 14 wherein the pump comprises an electrostatic diaphragm based micropump.

19. A method comprising:
receiving incoming contaminated air;
oxidizing the air at a temperature sufficient to remove chemical toxicity;
cooling the air to a breathable temperature; and
providing the air to a user for breathing.

20. The method of claim 19 wherein the temperature is sufficient to remove viability from biological materials.

21. The method of claim 20 wherein chemical toxicity and biological materials are rendered to a non-toxic state for breathing air protection.
